(19) United States
(12) Patent Application Publication
(10) Pub. No.: US 2001/0006189 A1
(43) Pub. Date: Jul. 5, 2001

(54) Process for the optical coding of an internet address printed on a visible support

(76) Inventor: David Ruby, Paris (FR)

Correspondence Address: KOLISCH HARTWELL DICKINSON MCCORMACK & H, EUSER, 520 S.W. YAMHILL STREET, SUITE 200, PORTLAND, OR, 97204

(21) Appl. No.: 09/755,543

(22) Filed: Jan. 3, 2001

(30) Foreign Application Priority Data
Jan. 4, 2000 (FR) 0000058

(51) Int. Cl. G06F 17/00

(52) U.S. Cl. 235/375

(57) ABSTRACT

According to this process for the optical coding of an Internet address printed on a visible support, to allow computer processing thereof, of the type according to which a cue incorporated into a coded printed mark which can be read by a scanner is associated with the address, the cue may be arranged in at least one of the dots of the Internet address. This cue may contain the identity of the visible support. The process includes the reading of the cue by a scanner.

### CROSS-REFERENCE TO RELATED APPLICATION

This application claims priority from French patent application Serial No. 0000058, filed Jan. 4, 2000.

### BACKGROUND

The present invention relates to a process for encoding information and its particular application to the marking of an Internet address.

The explosion in the market which is generally characterizing the fields of microcomputing and communication is even more marked with regard to everything concerned with the Internet.

There are more and more Internet users, both in a personal capacity and a professional capacity and numerous companies and organizations see in the Internet a very important tool for their development. The number of Internet sites is therefore growing very rapidly and the mechanism of publicizing them is beginning to be seriously considered. The most widespread mechanism of publicizing an Internet site address is to advertise it in the written press and the various newspapers and magazines are already inundated with such adverts where one finds, in addition to the name of the company and a possible description of its services, the address of its Internet site.

The average reader should not be expected to be able to retain the addresses of all the sites of interest to him, since there are very many of them and they are more are more difficult to memorize once the mnemotechnical names have already been taken. Generally, the addresses of interest are written on various supports (notes, jotting pads, etc.) which end up in a heap or get lost in part. This situation is therefore unsatisfactory.

Moreover, it is not easy for an advertiser who inserts his address in the press to measure the impact of his advert, or, if he has used several organs of the press, to ascertain which was the most efficient.

The document WO 9849813 discloses a destination website access and information gathering system in which a cue incorporated into a coded printed mark which can be read by a scanner is associated with an address printed on a visible support. This mark is a bar code printed on the visible support alongside the Internet address and containing various items of information such as the identity of the Internet destination site or the identity of the visible support.

However, this system appears to be too complex to be able to be generalized and moreover, the presence of a visible bar code on the printed support is not always compatible with the visual effects sought by advertisers.

An object of the invention is to remedy this difficulty.

### SUMMARY

The invention achieves its object by providing a process for the optical coding of an Internet address printed on a visible support, to allow computer processing thereof. The process involves the step of incorporating a cue into a coded printed mark which can be read by a scanner. Such incorporating step is characterized in that it includes incorporating the cue in at least one of the dots of the Internet address. In this way, the coded cue is located in a discreet place which is a necessary prerequisite of the Internet address.

Advantageously, the two dots of any Internet address are used to code the information. The shape of the coding itself is very free and depends on the complexity of the information which one wishes to transmit in this way.

### BRIEF DESCRIPTION OF THE DRAWINGS

FIG. 1 shows a setup diagram allowing the implementation of the process of the invention.

FIG. 2 illustrates an exemplary address coded in accordance with the invention.

FIG. 3 shows an exemplary coding used in the address of FIG. 2.

### DETAILED DESCRIPTION OF THE INVENTION AND BEST MODE FOR CARRYING OUT THE INVENTION

Circular coding shapes are known, for example, from the documents U.S. Pat. Nos. 5,861,613 and 5,103,081. Since we are dealing with a generally simple cue, such as to ascertain which of the various press media used is the one which sends the most readers to the site, a fairly simple coding can be used, such as a hexadecimal coding based on the angular position of a radius of the circle. A combination of the two circles makes it possible to code 16×16=256 different items of information. Naturally, it is possible to choose other shapes of codings, using for example, several radii per circle, or based on any other property allowing optical coding in the simplest and safest manner.

According to the invention, the process for processing an Internet address includes scanning the address encoded according to the process mentioned above with a scanning pen, and sending the scanned cue to a device for centralizing and redistributing this cue with a view to its transmission by the author of the advert.

The scanning pen preferably includes, in addition to reading mechanism, storage mechanism and mechanism for transmitting data to a computer whose job is to retransmit the cue to the advertiser periodically or in real time.

Other advantages and characteristics of the invention will become apparent from reading the following description with reference to the appended drawings.

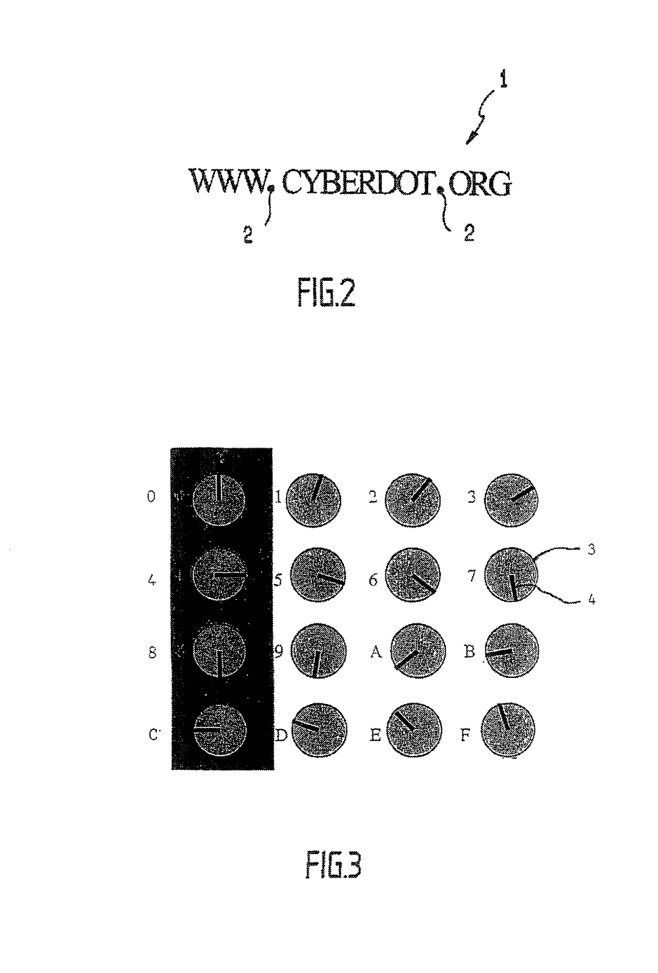

FIG. 2 shows an exemplary Internet address 1 including two separator dots 2 which are used in accordance with the invention to include a coded cue. In the example represented, use has been made of the coding illustrated in FIG. 3, where the 16 characters of the hexadecimal code are coded in the shape of a circle 3 with a radius 4 whose angular position varies to indicate a specified character.

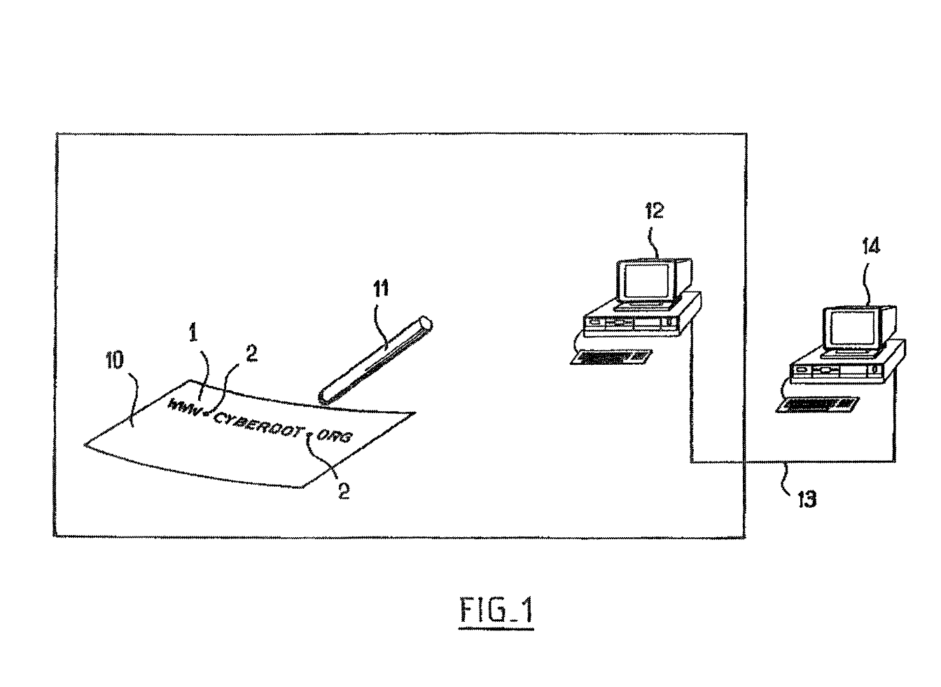

As shown by FIG. 1, the address 1 with its two coded dots 2 is printed on a visible support 10. The interested reader passes a scanner 11 over the address 1 (the former including either a specific optical reader, or a reader built into an apparatus such as a portable telephone for example) to read the cue coded in the dots. This cue can be stored temporarily in the scanner 11 by virtue of the storage mechanism.

This cue is then transmitted by wire or other mechanism to the user's workstation 12 and is then conveyed by an Internet network 13 to a computer 14 intended for retrieving and processing the cue. This may, in particular, be a computer which gives the advertiser who published the Internet address on the printed support the cue enabling him to determine the printed support in question.

I claim:

1. A process for the optical coding of an Internet address comprising the steps of:
printing the Internet address on a visible support to allow computer processing thereof,
incorporating a cue into a coded printed mark which can be read via a scanner, the coded printed mark being associated with the address by arranging the cue in at least one of the dots of the Internet address.

2. The process according to claim 1, wherein the incorporated cue contains the identity of the visible support.

3. The process according to claim 1, which further comprises the reading of the cue via a scanner.

4. The process according to claim 2, which further comprises the reading of the cue via a scanner.
